(19) United States
(12) Patent Application Publication
(10) Pub. No.: US 2022/0170300 A1
(43) Pub. Date: Jun. 2, 2022

(54) DOOR BRACING DEVICES

(71) Applicant: NeM Holdings, LLC, Bessemer, AL (US)

(72) Inventor: Eric Dutton, McCalla, AL (US)

(21) Appl. No.: 17/530,419

(22) Filed: Nov. 18, 2021

Related U.S. Application Data
(60) Provisional application No. 63/119,312, filed on Nov. 30, 2020.

(51) Int. Cl. E05C 19/18

(52) U.S. Cl. CPC E05C 19/18

(57) ABSTRACT

A door bracing device is described herein. The door bracing device includes an anchor structure positioned at a first end of the door bracing device, the anchor structure configured to extend outward from a base of the door bracing device to engage with a door handle. The door bracing device further includes a bolt receiver formed to receive a bolt of a door, the bolt receiver positioned such that the bolt of the door is able to extend through the bolt receiver. The door bracing device further includes a strike plate engagement structure positioned on a second end of the door bracing device, configured to extend outward from the base to be inserted into a strike plate of a door jamb of a door.

### CROSS REFERENCE TO RELATED APPLICATIONS

The present application claims the benefit of U.S. Provisional Patent Application No. 63/119,312 entitled “Door Bracing Devices”, filed on Nov. 30, 2020. The entire contents of the above-listed application are hereby incorporated by reference for all purposes.

### BACKGROUND

Doors are a critical component of buildings in that they allow ingress and egress while providing control or security for the building or individual rooms or spaces. Doors allow for control of passage of adults, children, pets, and other guests or occupants. Doors also provide occupants and security and privacy from pets, potential threats, or can be used as safety mechanisms. The privacy and security of the door can be provided as a hinged, sliding, or revolving barrier at the entrance to a building, or a room. Conventional doors are configured to open and close by pivoting around a hinge system. In the open position, the door is supported by the hinges alone. In the closed position, the door is supported by the hinges and secured in the closed position by a linear bolt or latch which engages a strike plate in a door frame and is operated by a doorknob or handle. The linear bolt or latch is capable of securing the door with the door frame, resulting in the door being secured and separated from the exterior area and climate outside of the door.

### BRIEF DESCRIPTION OF THE DRAWINGS

The present description will be understood more fully when viewed in conjunction with the accompanying drawings of various examples of door bracing devices. The description is not meant to limit the door bracing devices to the specific examples. Rather, the specific examples depicted and described are provided for explanation and understanding of door bracing devices. Throughout the description the drawings may be referred to as drawings, figures, and/or “FIG.”.

FIG. 1 illustrates a door bracing device engaged with a door handle and bolt of the door handle, according to an embodiment.

FIG. 2 illustrates the door bracing device of FIG. 1 secured relative to a strike plate of a door jamb, according to an embodiment.

FIG. 3 illustrates a first perspective view of the door bracing device of FIG. 1, according to an embodiment.

FIG. 4 illustrates a second perspective view of the door bracing device of FIG. 1, according to an embodiment.

FIG. 5 illustrates a first perspective view of an door bracing device that is adjustable, according to an embodiment.

FIG. 6 illustrates a bottom view of the door bracing device that is adjustable of FIG. 5, according to an embodiment.

FIG. 7 is an exemplary flow diagram of a door bracing device, according to an embodiment.

### DETAILED DESCRIPTION

Door bracing devices as disclosed herein will become better understood through a review of the following detailed description in conjunction with the figures. The detailed description and figures provide merely examples of the various embodiments of door bracing devices. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional door bracing device may include a door stop, a bracing leg, a magnetic coupler, and the like. Conventional door bracing devices such as door stops utilize friction with the floor to prevent a door from closing. Conventional door bracing legs apply an angular force to a floor to maintain the door in an open position. Door stops and bracing legs both rely on friction to prevent movement in the door friction can result in wear and tear of both the device and the surface against which the device creates friction. Additionally, many conventional door bracing devices are only able to prevent movement in the door in one direction. For example, doorstops prevent the door from either closing or opening but a single conventional doorstop cannot resist forces applied to the door in different directions. Although conventional doors provide convenience and functionality to the user, they also come with limitations and significant drawbacks, that limit a user from customizing the door's ability to fit their daily lifestyle.

Conventional doors often can be a hindrance to the proper regulation of the interior climate of a dwelling, or much needed air flow to facilitate a comfortable temperature. Under various climate environments it has become increasingly important to support current heating, ventilation, and air conditioning (HVAC) systems by ensuring that proper ventilation is able to be provided through an entire dwelling where there may be a plurality of doors hindering air flow. Without the proper air flow throughout an interior dwelling, some rooms separated by a door, can have disparate temperature from other rooms or enclosed spaces. In order to ensure that a temperature or a climate can be more consistent throughout a dwelling, it has become very important for occupants to implement ways of facilitating air flow in order to achieve optimum comfort as well as energy efficiency, through a door bracing device.

For example, the closure of interior doors can restrict airflow from HVAC ducts by creating a vacuum where the air handler system is trying to retain air that it is unable to receive. Due to this, an unusual strain on the system is caused that also increases energy consumption. The increase in energy consumption facilitates an increase in wear and tear that could lead to potential early system failure. In addition, the vacuum will begin to pull air from any available crack or flaw in the sealed HVAC system, thus reducing air quality. As such, the reduction of air quality can create major issues within the breathable air that includes an increase in contaminants such as dust, mold, and mildew amongst other contaminants, from entering the system or home through crawl spaces, attics, windows or doors.

Embodiments of door bracing devices may address some or all of the problems described above. Door bracing devices may attach to a door handle and interface with a strike plate of a door jamb to create a stable bracing of the door. The interface with the strike plate provides a point of security for stabilizing the door against forces applied from multiple directions. Door bracing devices as described herein may allow for air flow to occur while managing passage of pets, children, adults, etc. In some embodiments, securing a door with embodiments of the door bracing device may prevent unexpected or unwanted closure or opening of the door due to air movement, children, pets, etc. Embodiments may be positionable on the door to be out of reach of a pet and/or child to resist tampering.

The door bracing device may include an anchor structure extending outward to engage with a door handle. The anchor structure may be positioned at one end of the door bracing device and configured to secure to a handle or knob of the door. The door bracing device can further include a bolt receiver formed to receive a bolt of the door. The bolt receiver may be positioned such that the bolt of the door may be able to extend through the bolt receiver. The door bracing device may further include a strike plate engagement structure positioned on a second end of the door bracing device, opposite of the anchor structure. The strike plate engagement structure may be configured to extend outward to be insert into a strike plate of a door jamb of the door. The strike plate engagement structure may be configured to fill the opening in the door frame where the bolt of the door would have been intended to be inserted. Thus, the door bracing device secures the door in an ajar open position, while allowing for sufficient air flow to pass through the opening. Air flow being able to flow through the opening allows existing HVAC systems to more efficiently provide an efficient temperature within multiple rooms, and throughout the entirety of an interior dwelling or building.

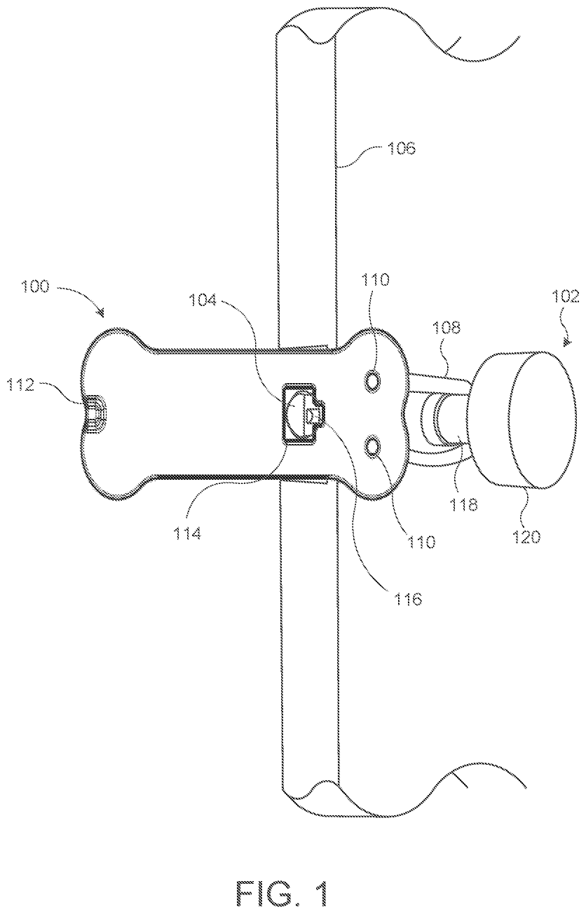

FIG. 1 illustrates a door bracing device 100 engaged with a door handle 102 and a bolt 104 of the door handle 102, according to an embodiment. For example, some embodiments allow for a stabilization of a door 106 by coupling the door bracing device 100 to the door handle 102 in an intuitive and non-destructive manner.

Embodiments of the door bracing device 100 may include an anchor structure 108 attached to the door bracing device 100 at one or more anchor points 110 formed at a first end of the door bracing device 100. The anchor structure 108 may be configured to couple the door bracing device 100 to a door handle 102. The anchor structure 108, in one example, can be coupled to the door handle device in order to create resistance between the door bracing device 100 and the door knob 102. In the instant example, the anchor structure may be secured to the first end of the door bracing device 100, would be secured to a portion of a doorknob or door handle 102 or another fixed structure on the door 106. Due to resistance created by the wrapped portion of the retention ring, the first end of the door bracing device 100 would be secured and stabilized against the inside frame of the door 106.

In some embodiments, the anchor structure 108 may extend from one of the anchor points 110 to form a loop and connect back to another of the anchor points 110. In other embodiments, the anchor structure 108 may be a hook or another non-closed geometry with connection to a single anchor point 110 on the door bracing device 100. In some embodiments, the anchor structure 108 may be adjustable in length. Some examples of the anchor structure 108 may include a ball chain that may be fixed or adjustable in length, an elastic element, a rope, a cord, a strap, a hook, a tie, a hoop, or so forth. In some embodiments, the anchor structure 108 may be rigid. In other embodiments, the anchor structure 108 may be flexible. The anchor structure 108 may be made of a wide range of materials including natural and synthetic materials or a combination of both natural and synthetic materials.

In some embodiments, the anchor structure 108 from the door bracing device 100 is configured to engage with the door handle 102. For example, the anchor structure 108 may loop around a shaft 118 of the door handle 102 by stretching, being loosened, or so forth to allow passing of the anchor structure 108 over the handle portion 120 of the door handle 102 to engage at the shaft 118 of the door handle 102. In some examples, the anchor structure 108 loops entirely around the shaft 118 of the door handle 102. In other examples, the anchor structure 108 may pass over a top side of the shaft 118 and down a far side of the shaft 118 from the door bracing device 100 in a hook-like attachment. Other manners of engaging the anchor structure 108 with the door handle 102 may be implemented.

In some embodiments, the door bracing device 100 also includes a bolt receiver 114. The bolt receiver 114 may be a cutout formed in the body of the door bracing device 100. In some embodiments, the bolt receiver 114 may be a cutout shaped to fit the bolt 104 of the door handle 102. For example, the bolt receiver 114 may be primarily rectangular with a notch to accommodate a bolt 104 that may include a deadlock plunger 116. Other embodiments of the bolt receiver 114 may omit the notch for the deadlock plunger 116. Some examples of the bolt receiver 114 may include non-rectangular geometries. Accordingly, the bolt 104 of the door handle 102 can protrude through the cutout that forms the bolt receiver 114. As the bolt protrude through the bolt receiver 114, the bolt 104 in an extended position, provides additional stability of the door bracing device 100 against the inside frame of the door 106.

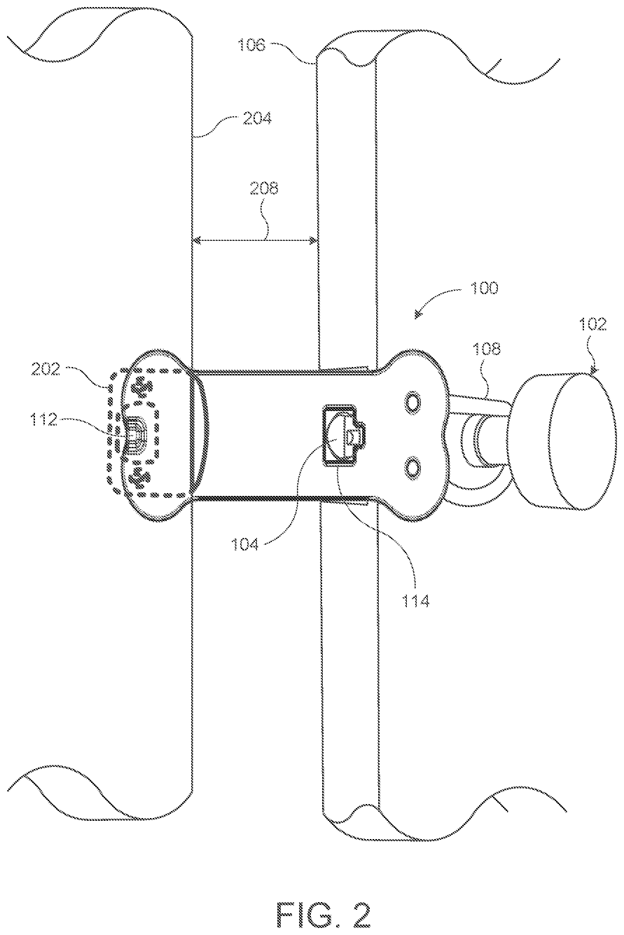

The door bracing device 100 also includes a strike plate engagement structure 112, positioned on the second end of the door bracing device 100. The strike plate engagement structure 112 extends outward from a surface of the door bracing device 100 to engage with a strike plate 202 (see FIG. 2).

In some embodiments, strike plate engagement structure 112 may be positioned in the door bracing device 100 to be opposite the anchor points 110 in the door bracing device 100. In some embodiments, the strike plate engagement structure 112 protrudes from the surface of the door bracing device 100. In some embodiments, the strike plate engagement structure 112 may be positioned to be central to the base of the door bracing device 100. Position the strike plate engagement structure to be central, allows the door bracing device 100 to be balanced from the second end, to the first end.

The strike plate engagement structure 112 may have a wide range of geometries. For example, the strike plate engagement structure 112 may have a U-shaped geometry. The top of the “U” may open away from the bolt receiver 114 and the anchor points 110. The curved part of the U and top edge of the “U” prevents the strike plate engagement from releasing from within a lock cavity within the door frame. The strike plate engagement structure 112 may be a separate element attached to the body of the door bracing device 100 or may a unified or monolithic part of the door bracing device 100. In some embodiments, the strike plate engagement structure 112 may include the same or similar material to that of the body of the door bracing device 100. In other embodiments, the strike plate engagement structure 112 may include one or more materials that are different from that of the body of the door bracing device 100. In another embodiment, the strike plate engagement structure 112 is configured to be removably replaced with a second strike plate engagement.

FIG. 2 illustrates the door bracing device 100 of FIG. 1 secured relative to a strike plate 202 of a door jamb 204, according to an embodiment. Embodiments secure the door in a partially open arrangement that may be resistant to forces that, when applied, would otherwise cause an opening or closing of the door relative to the door jamb.

In some embodiments, the door bracing device 100 may be configured to couple to the door handle 102, the bolt 104, and the strike plate 202. In some embodiments, the door bracing device 100 may engage with the door handle 102 via an anchor structure 108 which may be looped over the door handle 102. In some embodiments, the door bracing device 100 may also engage the bolt 104 at a bolt receiver 114 of the door bracing device 100, which bolt receiver 114 may be sized to allow the bolt 104 to pass through a thickness of the door bracing device 100. In some embodiments, the strike plate engagement structure 112 may be inserted into the strike plate 202. In an exemplary example the strike plate engagement structure 112 may be able to be inserted into the strike plate 202 opening of a door jamb of the door frame 204. Thus, the strike plate engagement structure 112 may be configured to fill the opening in the door frame where the bolt 104 of the door 106 would have been intended to be inserted. The insertion of the strike plate engagement structure 112 provides stability for the second end of the door bracing device 100 and a secure ajar opening creating the separation distance 208 between the door 106 and the door frame 204.

In some embodiments, a length of the door bracing device 100 may determine the separation distance 208 of the door 106 from the door jamb 204. In some embodiments, the length of the door bracing device 100 may be fixed. In other embodiments, the length of the door bracing device 100 may be adjustable. For example, the door bracing device 100 may be telescopic, have swappable components, or otherwise include structure or functionality to provide an adjustable length. In some embodiments, the adjustability may facilitate air flow control for more or less air flow, passage of certain pets and restriction of others, customization for specific room considerations or characteristics, or so forth.

In some embodiments, the door bracing device 100 may include multiples of one or more components to facilitate flexibility. For example, the door bracing device 100 may include multiple bolt receivers 114 or multiple strike plate engagement structures 112 to facilitate setting the distance between the door 106 and the door jamb 204 or for compatibility with a variety of different door arrangements.

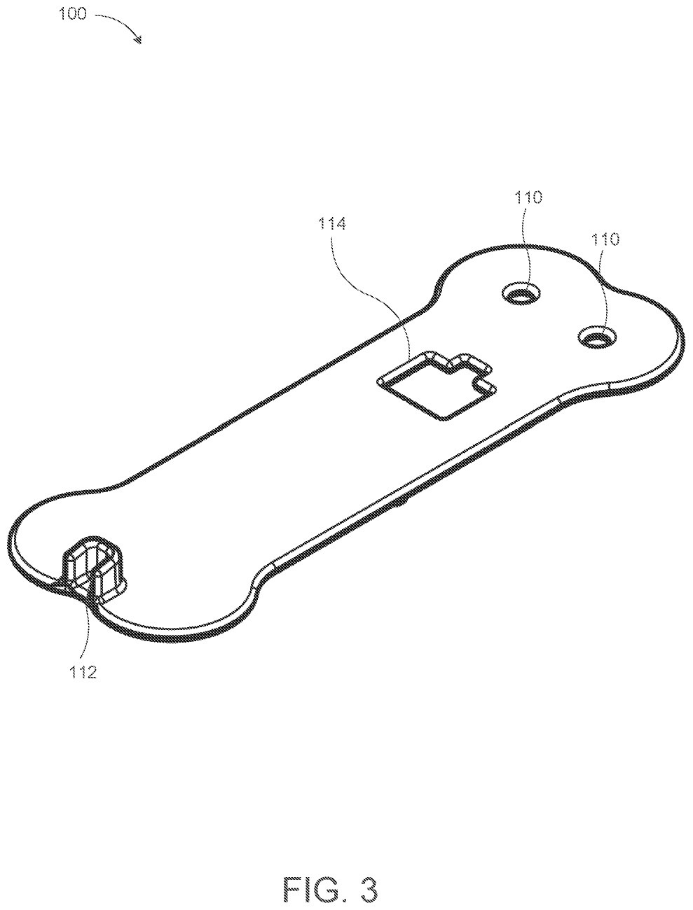

FIG. 3 illustrates a first perspective view of the door bracing device 100 of FIG. 1, according to an embodiment. Embodiments of the door bracing device 100 provide an intuitive and simple system for bracing a door in a partially open position to allow for unique control of passage through the doorway for air, pets, children, adults, etc. For example, the door bracing device 100 may brace open the door at a spacing to allow a first animal (such as a cat) to pass through a doorway while prohibiting a second animal (such as a dog) or child from passing through the doorway. In another example, the door bracing device 100 may brace the door open at a spacing that may be sufficient to allow air flow without allowing a pet or child to pass through the doorway. In another example, the door bracing device 100 may brace the door in such a way as to resist air flow created by an air conditioning unit or air pressure from an open window but release the door in response to a threshold amount of pressure being applied by a user in case of an emergency such as a fire. In one example, a threshold amount of pressure can include at least 50 lbs. of pressure applied to center mass of the door.

In some embodiments, the door bracing device 100 has a dog bone shape. In other embodiments, the door bracing device 100 has a crayon shape, an ice cream cone, a pencil, a baby rattle, or so forth. In some embodiments, the door bracing device 100 may have a structural shape that provides an aesthetic element or quality to improve an appearance of the door bracing device 100, indicate a corresponding applicability (dog bone for use with dogs, crayon for use with kids, wind gust for use with air conditioning unit, etc.). In other embodiments, the door bracing device 100 may accept a cover, tag, label, indicator, or other aesthetic element.

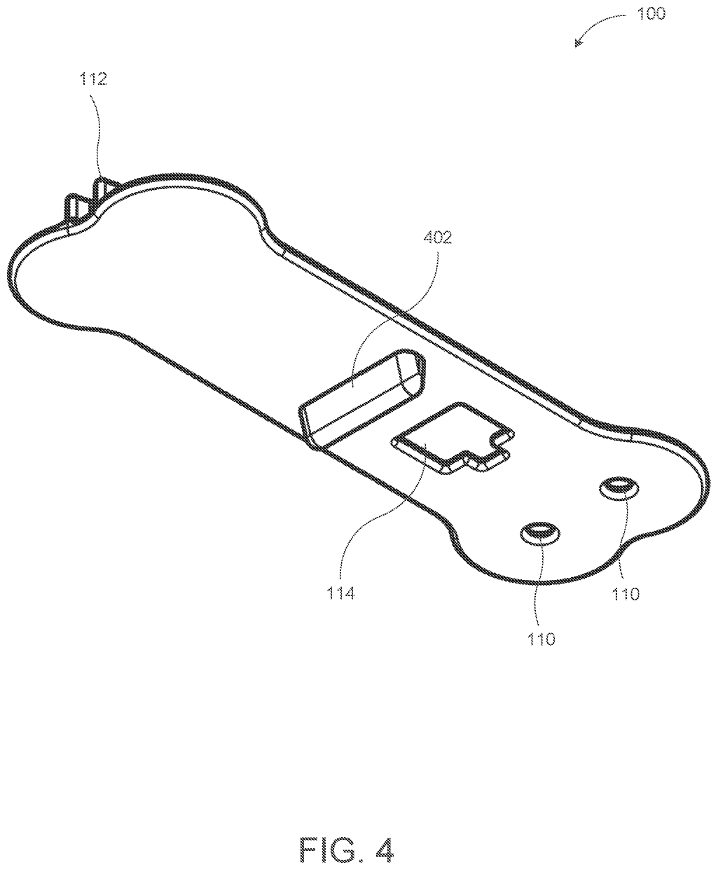

FIG. 4 illustrates a second perspective view of the door bracing device 100 of FIG. 1, according to an embodiment. Embodiments provide a secure bracing option for a wide range of doors and door jambs to allow a user to secure the door relative to the door jamb in neither a fully closed or fully open position but in a partially open position.

In some embodiments, the door bracing device 100 includes a slide stop 402. In some embodiments, the slide stop 402 extends outward from the door bracing device 100. The slide stop 402 may be positioned between the bolt receiver 114 and the strike plate engagement structure 112. In some embodiments, the slide stop 402 may be positioned proximate the bolt receiver 114 to support the door 106 with the bolt 104 engaged with the bolt receiver 114. In some embodiments, the slide stop 402 may have an elongated geometry to extend parallel to the door 106. In some embodiments, the geometry of the slide stop 402 may reduce a chance of damage to the door 106. In some embodiments, the slide stop 402 may form a barrier to reduce a likelihood of the bolt 104 unintentionally disengaging from the bolt receiver 114.

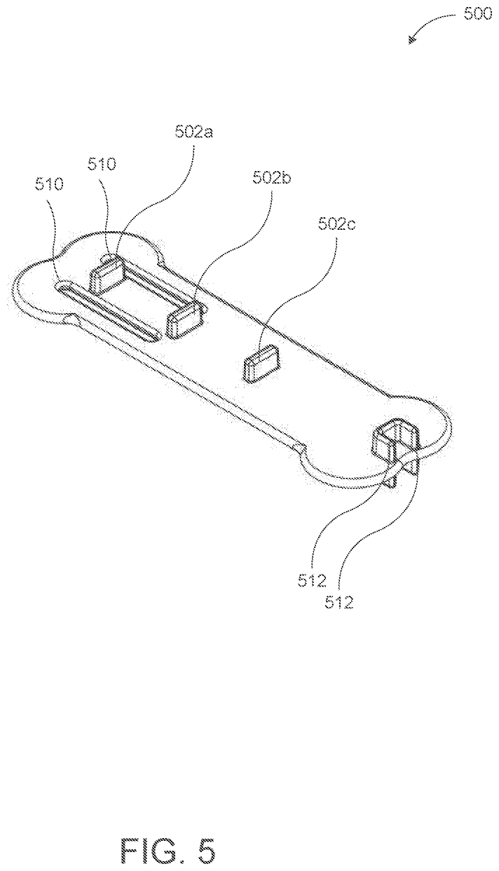

FIG. 5 illustrates a first perspective view of a door bracing device that may be adjustable, according to an embodiment. The adjustable door bracing device 500 includes two anchor slots 510 that are configured to receive an anchor structure, similar to what is described in FIG. 1. The anchor slots 510 allow the anchor structure to be secured and adjusted along the elongated slot as the anchor structure may be secured to an associated shaft of the door knob or door handle. A loop structure as shown in FIG. 1, will be utilized to secure the door bracing device 500, via of the two anchor slots 510, that is wrapped around the shaft of a door handle. For example, a ball chain can be utilized that goes through one of the anchor slots 510, loops around the shaft of the door handle, and through the other unused anchor slot 510, reattaching to itself forming a looped attachment.

The anchor structure or bolt receiver may further include multiple slide stops, such as a first slide stop 502a, a second slide stop 502b, and a third slid stop 502c. The slide stops 502a-c may extended outward from the adjustable door bracing device 500. The slide stops 502a-c have an elongated geometry that may reduce damage to the door and/or maintain a separation between the door and the door frame. Each position of the slide stops 502a-c allows a user to set a preferred door separation between the door and the door frame. The adjustability of the door can be implemented by a bolt or latch of a door knob, a door knob, a handle, or the door face being positioned between two of the slide stops. The adjustable door bracing device 500 may include various numbers of slide stops (such as 4 slide stops, 5 slide stops, 6 slide stops, and so forth) to allow a user to adjust the separation of the door and the door frame to a desired distance. In one example, a bolt or latch of a door knob, a door knob, a handle, or the door face may be in a first position between slide stops 502a and 502b to create a separation of 3.5 inches. In another example, the bolt or latch of a door knob, a door knob, a handle, or the door face may be positioned between slide stops 502b and 502c to create a separation of 2.0 inches. As such, multiple different lock positions are created for the user to establish the door separation. Alternatively, additional doorstops can be added in different positions on the base of the door bracing device 500, in order to create different ranges for door separation and adjustability.

The adjustable door bracing device 500 further includes a strike plate engagement structure 512 that may be configured to fill the opening in the door frame where the bolt 104 of the door 106 would have been inserted, securing the adjusted separation by the user. The strike plate engagement 512 may be configured to allow the adjustable door bracing device 500 to be secured on the opposite end of the anchor slots 510. Upon the strike plate engagement 512 is inserted into the opening in the strike plate of the door frame, the door bracing device 500, is secured within the door frame. In one example, the adjustable door bracing device 500 may serve as an extension of the door frame.

In one example, the adjustable structure of the body comprises telescopic components or removable components configured to adjust the base to one or more lengths. The telescopic components can be removed and secured to create a longer or shorter body per the predetermined length requirements of the user.

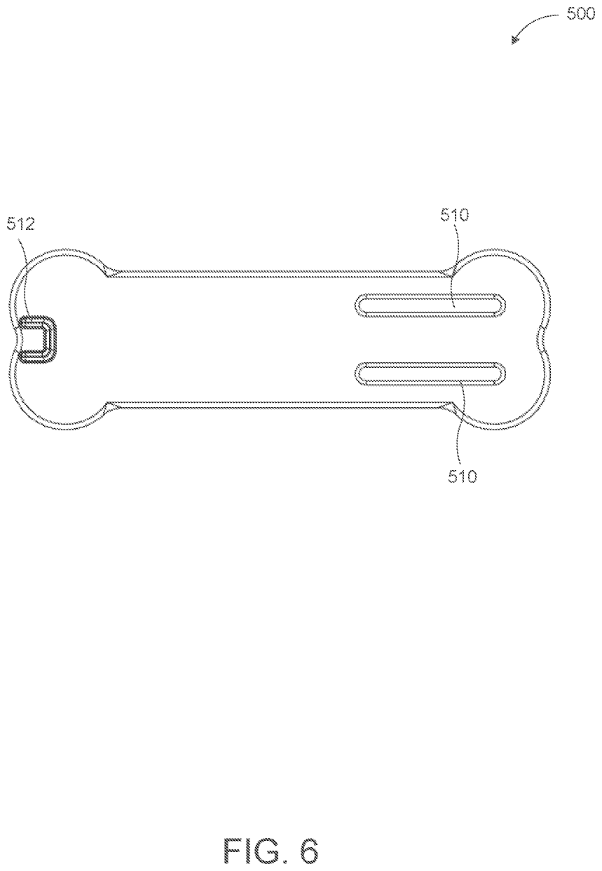

FIG. 6 illustrates a bottom view of the door bracing device 500 that may be adjustable of FIG. 5, according to an embodiment. Embodiments thereof are configured to provide a user the ability to slidably adjust an anchor structure as shown in FIG. 1, in accordance with the desired door to door frame separation a user desires. The anchor structure can be adjusted by the user based on the amount of air flow that may be desired to regulate temperature, or provide enough passage for a pet but restrict passage for a child. Due to the flexibility of adjustment, the adjustable door bracing device 500 may be able to fit the needs of a user, based on their preference. In one embodiment, there can be a second strike plate engagement that allows the user to flip over the device 500, and implement usage in instances where the slide stops 502 are not needed.

For example, the bottom view of the door bracing device 500 can create additional usability in commercial settings, or to be compatible with doors of a thicker width, or 1.75 inches or more. As such, using the bottom side of the door bracing device 500 allows a user to use the device 500 regardless of the door that is being propped open to create the separation of the door and door frame. Accordingly, the door separation can be configured to have a range of 2 inches to 4 inches depending on the width of the door.

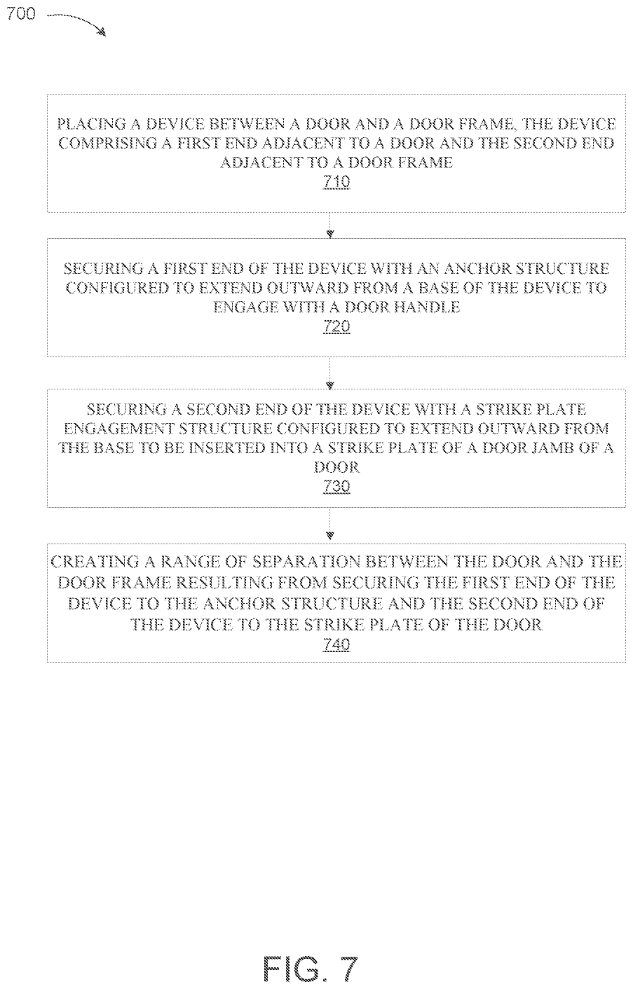

FIG. 7 is an exemplary flow diagram of a method 700 of a door bracing device, according to an embodiment. The method includes placing a device between a door and a door frame, the device comprising a first end adjacent to a door, and the second end adjacent to a door frame 710. The device is secured by securing a first end of the device with an anchor structure configured to extend outward from a base of the device to engage with a door handle 720. The method further includes securing a second end of the device with a strike plate engagement structure configured to extend outward from the base to be inserted into a strike plate of a door jamb of a door 730. The device maybe be capable of creating a range of separation between the door and the door frame resulting from securing the first end of the device to the anchor structure and the second end of the device to the strike plate of the door 740. The range of separation may be created from the securing of the first end of the device to the door handle and the bolt of the door. The range of separation may be also created from the second end of the device being inserted into the strike plate of the door. The range of separation is directed towards creating a spacing from 2 inches to 3.5 inches to allow passage of ventilation of air flow only, or a small pet, respectively.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description may be intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively inclusive elements includes at least one element of the listed elements. However, an example described using a list of alternatively inclusive elements does not preclude another example that includes all of the listed elements. An example described using a list of alternatively inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A device comprising:
a body structured as a dog bone shape having an adjustable structure positioned central to and adjoining a first end and a second of the device, the adjustable structure configured to create a threshold spacing, wherein the threshold spacing is created within a doorway created between a door and a door frame and provide a brace configured to affix the door and the door frame relative to the created spacing to control of passage through the doorway;
an anchor structure configured to couple a door handle device, the anchor structure comprising:
a set of anchor points centrally positioned on the first end of the device;
an anchoring device configured to form a loop or a hook from a first anchor point to a second anchor point, the loop or hook configured to be affixed around a shaft of the door handle creating a resistance between the first end about the set of anchor points and a door knob of the door; and
a bolt receiver positioned at the first end of the device positioned at the first end of the device receive a bolt or latch of the door handle device; and
a strike plate engagement structure positioned on the second end of the body, the strike plate engagement structure configured to extend outward from a surface of the device and engage with a strike plate of a door frame.

2. The device of claim 1, wherein the bolt receiver further comprises a first slide stop and a second slide stop positioned at the first end of the device, wherein the first slide stop and the second slide stop are configured to:
receive a door and secure the door from reducing or increasing the threshold spacing; and
prevent the door from closing in the event the bolt is dislodged from the bolt of the receiver.

3. The device of claim 2, wherein the bolt receiver is configured to restrict a door from moving in an inward direction while being braced by the strike plate engagement structure.

4. The device of claim 2, further comprising a third slide stop, wherein:
the first slide stop and the second slide stop are configured to receive at least one of the bolt, the latch, the door knob, a handle, or a door face at a first predetermined length from the strike plate engagement structure to allow a small animal to enter a passageway; and
the second slide stop and the third slide stop are configured to receive at least one of the bolt, the latch, the door knob, a handle, or a door face at a second predetermined length from the strike plate engagement structure to restrict a small animal from entering the passageway while allowing ventilation from a heating, ventilation, and air conditioning (HVAC) system.

5. The device of claim 4, wherein:
the first predetermined length is configured to allow passage of a cat and narrow enough to restrict passage of a dog; and
the second predetermined length is configured to allow passage of an air flow while restricting passage of a dog, a cat, or a child.

6. The device of claim 2, further comprising a fourth slide stop.

7. The device of claim 1, wherein the anchoring device is adjustable in length and configured to be set to a first predetermined length or second predetermined length, creating a transition from a wider threshold spacing or a smaller threshold spacing based on air flow in a dwelling, or securing the dwelling from entry.

8. The device of claim 1, wherein the anchoring device comprises:
a ball chain;
an elastic element;
a rope;
a cord;
a strap;
a hook;
a tie; or
a hoop.

9. The device of claim 1, wherein the adjustable structure of the body comprises telescopic components or removable components configured to adjust the body or a component of the body to one or more lengths.

10. The device of claim 1, wherein the strike plate engagement is configured to be inserted into an opening in the door frame to secure the second end to the door frame.

11. A method comprising:
placing a device between a door and a door frame, the device comprising a first end adjacent to a door and a second end adjacent to a door frame; and
securing a first end of the device with an anchor structure configured to engage with a latch or bolt of a door knob of the door;
securing the second end of the device with a strike plate engagement structure configured to extend outward from a base to be inserted into a strike plate of the door frame;
creating a range of separation between the door and the door frame resulting from securing the first end of the device to the door and the second end of the device to the strike plate; and
wherein the range of separation is created from:
the securing of the first end of the device to the door shaft and a bolt of the door; and
the second end of the device being inserted into the strike plate of the door, such that the door is removably affixed to the door frame relative to the range of separation.

12. The method of claim 11, further comprising redirecting air flow created by an air conditioning unit or air pressure from an open window, wherein the air flow is redirected by restricting an air pathway created by the range of separation between the door and the door frame resisting air flow.

13. The method of claim 11, further comprising releasing the door in response to a threshold amount of pressure being applied by a user in case of an emergency.

14. The method of claim 11, wherein the strike plate engagement structure is configured to be positioned in one or more positions relative to the base of the device.

15. The method of claim 11, wherein the strike plate engagement structure is configured with a U-shaped geometry wherein:
the U-shape is configured to open away from the anchor structure; and
the U-shape prevents the strike plate engagement structure from releasing from within a lock cavity within the door frame.

16. A device comprising:
a base configured as a brace for creating a separation of space between a door and a door frame;
an anchor structure positioned at a first end of the base, wherein the anchor structure comprise a bolt receiver formed as an opening in the base to receive a bolt of a door, wherein the bolt receiver; and
a strike plate engagement structure positioned on a second end of the device, configured to extend outward from the base to be inserted into a strike plate of a door jamb of a door.

17. The device of claim 16, wherein the anchor structure further comprises:
a first bolt receiver and a second bolt receiver; or
a first strike plate engagement structure and a second strike plate engagement structure.

18. The device of claim 16, wherein the separation of space is created about a threshold of the door and the door frame and configured to allow air flow without allowing a pet or child to pass.

19. The device of claim 16, wherein the bolt receiver comprises a first slide stop and a second slide stop positioned.

20. The device of claim 16, wherein the bolt receiver is configured to be sized to allow a bolt to pass through a thickness of the base.
